(19) United States
(12) Patent Application Publication
(10) Pub. No.: US 2007/0160808 A1
(43) Pub. Date: Jul. 12, 2007

(54) Anisotropic conductive sheet

(76) Inventors: Yasuhiro Okuda, Osaka (JP); Taro Fujita, Osaka (JP)

Correspondence Address: MCDERMOTT WILL & EMERY LLP, 600 13TH STREET, N.W., WASHINGTON, DC, 20005-3096, US

(21) Appl. No.: 11/547,024

(22) PCT Filed: Mar. 30, 2005
(86) PCT No.: PCT/JP05/06731

§ 371 Date: Oct. 2, 2006

(51) Int. Cl. B32B 3/10

(52) U.S. Cl. 428/137

(57) ABSTRACT

The object of the invention is to provide an anisotropic conductive sheet which obtains good conductivity without damaging a wafer of a semiconductor nor electrode terminals of a conduction measurement instrument due to loading during inspection of the wafer.

An anisotropic conductive sheet 1 of the invention is formed such that a porous resin layer is formed on inner walls of a plurality of through holes perforated in the thickness direction of an electrically insulating porous sheet 2, and the surfaces of skeletons of the porous resin are coated with metal. Examples of the porous resin layer include those which are obtained by means of foaming a fluororubber or a tetrafluoroethylene-propylene copolymer rubber, having an open-cell structure, and cross-liking the same through irradiation with electron beams. The sheet is particularly favorable for a porous resin.

### BACKGROUND OF THE INVENTION

1. Field of the Invention

The present invention relates to an anisotropic conductive sheet, e.g., inspection of a semiconductor wafer, or the like.

2. Description of Related Art

An anisotropic conductive sheet has been employed in inspection means for determining whether or not a semiconductor wafer, in the state of a wafer, has been formed in conformance with specifications. In this inspection means, electrodes for conduction with circuits on the wafer are formed every plural chips formed on the wafer. Accordingly, the electrodes are formed in extremely high density. However, inspection must be performed without causing short-circuit between electrodes of an inspection device or the electrodes of the chip and other electrodes. When an anisotropic conductive sheet is sandwiched between the inspection device and the wafer, inspection can be performed without causing a short-circuit between the electrodes of interest and other electrodes.

The anisotropic conductive sheet is required to be durable because the sheet is not replaced after each inspection. Instead, the anisotropic conductive sheet is subjected to repetitive use. Moreover, the anisotropic conductive sheet is also required to be heat-resistant because the inspection is performed within a high-temperature atmosphere, such as at 150 to 200° C., which accelerates deterioration of the circuits. In addition to the above requirements, the anisotropic conductive sheet must be resilient in order to conform with asperities in the semiconductor wafer. Some wafers to be inspected have asperities of about 0.2 mm.

These required properties with respect to the anisotropic conductive sheet have been satisfied by controlling the properties of an insulating resin forming the sheet. For example, it has been proposed to use a porous material having communicating pores and to fill the pores with an elastomer (see JP-A-10-149722). In this way, heat-resistance and resilience of the resin can be effectively utilized.

In addition, a method for inspecting a wafer having many electrodes formed from aluminum has been proposed. Portions of aluminum electrodes that are exposed to the exterior are likely to be covered by oxide films. In this method, enhanced conduction is obtained by destroying the oxide films (see JP-A-2003-59611). Specifically, a conductive member, which is provided at an opening formed in an anisotropic conductive sheet in the thickness direction, projects from the surface of the sheet. Conduction is enhanced by causing the projection to destroy the oxide film on an opposing electrode.

### SUMMARY OF THE INVENTION

However, although the technique described in JP-A-10-149722 effectively utilizes the heat-resistance and resilience of the resin, the elastomer described in JP-A-10-149722 causes a lot of out gassing. This out gassing may cause faulty continuity at electrical contacts of a subject electric device. Accordingly, there is a need for an anisotropic conductive sheet capable of solving the problem pertaining to the technique of JP-A-10-149722, capable of performing inspection without damaging a wafer to be measured and/or electrode terminals of a measurement instrument due to loading, having good conductivity, and having enhanced durability.

An aspect of the invention is an anisotropic conductive sheet including a plurality of through holes perforated in the thickness direction of an electrically insulating porous sheet, and porous resin layers having an open-cell structure respectively formed on inner walls of the through holes, in which skeleton portions of the porous resin layers are coated with metal. By means of this configuration, even an inner side of the open-cell structure of the porous resin is coated with the metal. As a result, an area of the metal exposed to the sheet surfaces is increased, and there can be ensured large cross-sections of conductor portions of the circuit, at which connection is established through the sheet. In addition, the sheet can have sufficient durability against repetitive compression/decompression applied through repetitive use, and ensure uniform conductivity.

The insulating porous resin sheet is preferably formed by foaming a fluororubber.

In addition, the porous resin layer is preferably formed by a phase-separation method. In such a case, a layer having an open-cell structure can be obtained. As a matter of course, the layer may be formed by other means.

In particular, when the material having the porous structure is a fluororubber, the following advantages are provided: a low level of out gassing, and resolving faulty continuity at electrical connections of an electrical device which is a subject, in addition to being highly heat-resistant so as to endure continuous usage at 180° C., and having excellent durability.

When, among fluororubbers, a tetrafluoroethylene-propylene copolymer rubber which has been subjected to electron beam irradiation is employed, a cross-linked structure can be formed, and a favorable layer can be obtained.

The metal to be coated favorably contains at least one member selected from a group consisting of gold, silver, and copper. The metal may be in any form of a simple substance, an alloy, or a complex.

When the metal to be coated has an auxiliary layer formed from one or more of nickel, a nickel alloy, a precious metal, and a precious metal alloy, the metal can also be preferably employed. Preferable examples of the precious metal include gold, silver, and platinum. Examples of the precious metal alloy include alloys of these precious metals, alloys of a precious metal and nickel, and cadmium. As described above, a metal layer is also preferably formed into a multi-layer while employing a metal having a high conductivity or being less prone to oxidization, or a metal having both of these properties, as an auxiliary layer.

### BRIEF DESCRIPTION OF THE DRAWINGS

FIG. 1 is an enlarged, schematic cross-sectional view illustrating an exemplary embodiment of the present invention.

FIGS. 2A to 2D are explanatory views of a process for manufacturing the exemplary embodiment. FIG. 2A illustrates a state in which through holes are formed. FIG. 2B illustrates a state in which a porous resin is coated on the surface. FIG. 2C illustrates a state in which metal has permeated through the porous resin. FIG. 2D illustrates a state in which the front and the back surfaces have been removed, thereby obtaining an anisotropic conductive sheet.

FIG. 3 is an explanatory view of a conduction test employed in the invention.

Meanwhile, reference numeral in the drawings are as follows: 1 denotes an anisotropic sheet; 2 denotes an electrically insulating porous sheet; 3 denotes a through hole; 4 denotes a porous resin coated with metal; 5 denotes a porous resin; 10 denotes a gravimeter; 11 denotes an electrically insulating layer; 12 denotes a conductive plate; 13 denotes an anisotropic conductive sheet; 14 denotes a probe; 15 denotes a direction of movement; 16 denotes a constant current power source; and 17 denotes a voltmeter.

### BEST MODE FOR CARRYING OUT THE INVENTION

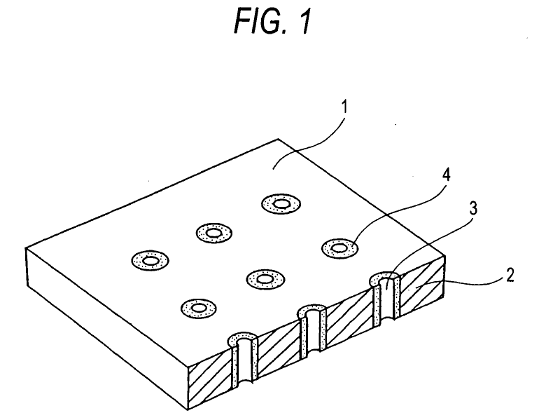

FIG. 1 illustrates, in an enlarged manner, a schematic view of an exemplary embodiment of an anisotropic conductive sheet 1. The view shows a cross-section of the anisotropic conductive sheet 1 with a cross-plane cutting across through holes 3. The through holes 3 are perforated through an electrically insulating porous sheet 2 and extend to the front and back surfaces of the anisotropic conductive sheet 1. Porous resin layers coated with metal 4 respectively cover inner walls of the through holes 3. End faces of the layers of coated porous resin 4 are exposed on the front and the back surfaces of the sheet 1, respectively. The end faces respectively oppose positions of electrodes of a semiconductor wafer and inspection electrodes. The inspection electrodes are to be connected to an inspection device.

The electrically insulating porous sheet 2 employed in the above configuration is preferably a foamed resin (e.g., a foamed rubber). More preferably, the electrically insulating porous sheet 2 is a foamed fluororubber, which is heat resistant and highly durable so that the sheet can withstand repetitive compression/decompression.

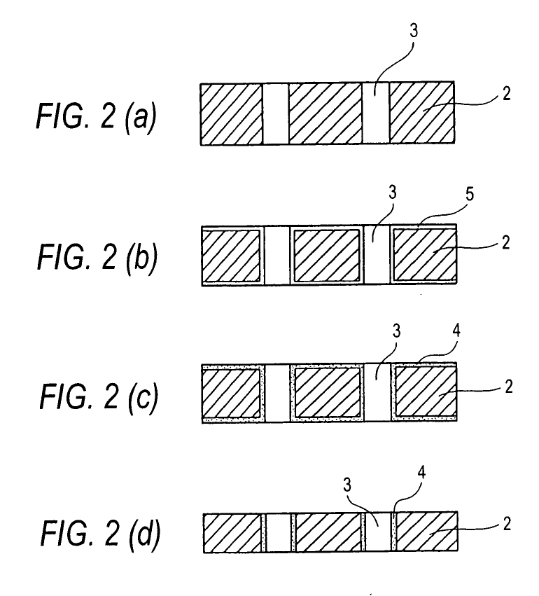

FIGS. 2A to 2D show an example method for manufacturing the electrically insulating porous sheet 2. First, an electrically insulating porous sheet 2 is prepared, and through holes 3 are formed therein. The through holes 3 are preferably perforated by some means that does not induce deformation, strain, or the like, on the through hole portions. Specific examples of such means include: a mechanical perforation method, such as a drill or a punch; and a method of utilizing ablation caused by synchrotron orbital radiation or a laser beam. FIG. 2A illustrates the electrically insulating porous sheet 2 in a perforated state with through holes 3 formed in the electrically insulating porous sheet 2.

The surface of the electrically insulating porous sheet 2 is preferably coated with a porous resin 5 by a phase separation method. A phase separation method is a method for manufacturing a porous film. In such a method, a polymer is dissolved in a good solvent (e.g., tetrahydrofuran (THF) in a case where AFLAS, a fluororubber, is employed). When the good solvent is brought into contact with a non-solvent, the good solvent and the non-solvent are replaced. While the concentration of the good solvent increases and that of the non-solvent increases, phase separation occurs, and primary particles having diameters on the order of about tens of nanometers are formed. Thereafter, these particles grow into secondary particles of about hundreds of nanometers to several μ in diameter, and, eventually, pores are formed in the form of gaps between the secondary particles.

As a matter of course, the method of coating the electrically insulating porous sheet with a porous resin 5 is not limited to the phase separation method, and any method, such as a micropore-forming material extraction method, is applicable, so long as it is a method that can coat the electrically insulating porous sheet 2, including the through holes 3, with the porous resin 5 having an open-cell structure. However, in the present invention, the phase separation method is preferably employed.

FIG. 2B illustrates a state in which the porous resin 5 has coated the surface of the electrically insulating porous sheet 2. The porous resin 5 preferably is coated uniformly over the front and the back surfaces of the electrically insulating porous sheet 2 and the interiors of the through holes 3.

The porous resins can be obtained as follows. A solution is prepared by dissolving a resin, which has heat resistance and durability that are similar to the resin employed in the electrically insulating porous sheet 2, into a solvent that can be gasified at a low temperature. The electrically insulating porous sheet 2 is passed through the solution, and dried, thereby obtaining the porous resin.

In particular, since the phase separation method is employed, the porous resin 5 forms an open-cell structure. Accordingly, the open-cell structure of the porous resin 5 can be coated with metal. A fluororubber is preferably employed as the porous resin because a fluororubber exhibits good conformability with the resin forming the electrically insulating porous sheet. Among fluororubbers, in particular, a tetrafluoroethylene-propylene copolymer rubber having been foamed and thereafter subjected to irradiation to form a cross-linked structure is preferable because it has good heat-resistance and durability. Examples of irradiation means for providing irradiation include an electron beam, a gamma beam, and an X-ray. However, electron beam irradiation is preferable, because electron beam irradiation has an energy intensity appropriate for cross-linking the porous resin, and being easy in handling.

FIG. 2C illustrates a state in which skeleton portions of the thus-coated porous resin 5 are coated with metal by electroless plating, or the like, so that the entire surface of the electrically insulating porous sheet 2, including the through holes 3, is coated with the porous resin, whose skeleton portions are coated with the metal 4.

The metal to be used in the above is preferably a metal having good conductivity, and more preferably one or more members selected from gold, silver, and copper. The metal to be coated maybe in any form of a single substance, an alloy, and a complex. Furthermore, preferably, a multi-layer structure is employed, with the front layer side being coated with an auxiliary layer formed from one or more members selected from among nickel, a nickel alloy, a precious metal, and a precious metal alloy. The auxiliary layer preferably has a higher resistance to oxidation or higher conductivity than the first layer, and more preferably is a metal excellent in both properties.

The porous resin coated with metal 4 is removed from the front and the back surfaces of the electrically insulating resin sheet 2, thereby obtaining the anisotropic conductive sheet with porous resin layers 4 illustrated in FIG. 2D. FIG. 1 depicts the anisotropic sheet of FIG. 2D as viewed from an upward oblique direction.

The thus-obtained anisotropic conductive sheet according to the exemplary embodiment includes an electrically insulating sheet as its substrate; porous resin layers having an open-cell structure on its perforated hole portions. A metal layer coats even the interiors of the open-cell structure. Accordingly, the anisotropic conductive sheet is excellent in elastic recovery against repetitive loading. In addition, since the metal layer coats the skeleton portions of the open-cell structure, even the metal portions are not hard, and have resiliency. Moreover, the metal layer cannot be exfoliated from the sheet and is less prone to deformation due to repetitive loading. In addition, since the metal coats the entire skeletons of the porous resin fabricated on the through perforated portions, the sheet can be viewed as having layers of metal extending from the front to the back sides of the sheet. That is, there can be ensured wide contact areas for the electrode terminals located above and below the sheet.

As described above, the anisotropic conductive sheet according to the invention has a long life and high reliability for conductivity.

Although an example of the present invention will be described in detail hereinbelow, the present invention is not limited to this example.

### EXAMPLE

### Preparation of Electrically Insulating Porous Sheet

One hundred parts by weight of polyvinylidene fluoride-hexafluoropropylene copolymer (DAI-EL G-701, manufactured by DAIKIN Industries, Ltd.), 2 parts by weight of azodicarboxamide (ADCA)-based foaming agent (CELLMIC CAP 250, manufactured by Sankyo-k. Co., Ltd.), 20 parts by weight of clay (Burgess #30, manufactured by Shiraishi Calcium Co., Ltd.) serving as foaming nucleator, 1.5 parts by weight of high-purity magnesia (Kyowa Mag MA-150, manufactured by Kyowa Chemical Industry Co., Ltd.), and 2 parts by weight of commercially-available calcium hydrate were mixed, kneaded with rollers, and thereafter formed into a preform sheet of 1 mm thickness. The preform sheet was placed in a sheet-forming mold of 2 mm depth, and heated for 20 minutes at 165° C., thereby obtaining a sheet-like foamed member. The foamed sheet was 50 μm in average pore size, and 40% in porosity.

Perforation of Sheet and Formation of Porous Resin

Through holes of 200 μm diameter were perforated in the foamed sheet with use of a micro-drill. The through holes were formed so as to have a center-to-center distance of 1 mm.

Separately from the above, there was prepared a solution in which a tetrafluoroethylene-propylene copolymer rubber (AFLAS 150C, manufactured by Asahi Glass Co., Ltd.) was dissolved in THF so that the rubber accounted for 5% by weight of the solution. The perforated foamed sheet was dipped in this solution, thereby causing the solution to permeate even the interiors of the through holes. Thereafter, the sheet was removed from the solution, and dried under an atmosphere of a temperature of 25° C. and a humidity of 95% RH, thereby causing THF to evaporate. After drying, a porous resin of about 30 μm thickness was observed, under an optical microscope on internal walls of the through holes formed in the sheet. The pore size of this porous resin was about 1 to 2 μm, and these pores were continuous with the interior.

The porous resin was irradiated with electron beam of 100 kGy, thereby inducing cross-linking. Permeation of Metal and Formation of Anisotropic Conductive Sheet

The thus-obtained foamed sheet on whose surface layer the porous resin had been formed was plated with copper by electroless plating. The process was performed as follows. After being pre-dipped with CR-3023 manufactured by Nikko Metal Plating Co., Ltd., the foamed sheet was subjected to electroless copper plating with NKM 554 manufactured by the same, with use of CP-3316 manufactured by the same as a catalyst, and NR-2A and NR-2B manufactured by the same as plating accelerators.

Thereafter, nickel plating was applied on the copper plating by means of electroless nickel plating. The process was performed as follows. After being degreased through alkaline-dipping with use of Rapid Clean P-5 manufactured by Nikko Metal Plating Co., Ltd., the foamed sheet was washed with water, followed by acid cleaning, and thereafter subjected to electroless plating with NKM 7N manufactured by the same.

On the surface of the nickel plating, displacement gold plating was applied. The process was performed as follows. After being cleaned with MICRO FAB 72 manufactured by Electroplating Engineers of Japan Ltd. (EEIA), the foamed sheet was washed with water, and subjected to acid pickling in hydrochloric acid, and thereafter to displacement plating with LECTROLESS Au 1100 manufactured by the same, to thus complete the displacement gold plating. The plated portion was observed to have copper plating of 0.5 μm thickness, nickel plating of 20 nanometers thickness, and gold plating of 30 nanometers thickness by use of a focused ion beam (FIB).

Both upper and lower surfaces of the foamed sheet, which was obtained through the above operations and on whose surface layers the porous resin was formed with the metal permeated therethrough, were sliced, thereby removing the surface layer portions where the porous resin and the foamed sheet were formed compact. As a result, a uniformly-foamed foamed sheet of 1 mm thickness was obtained. The foamed sheet had through holes formed with 1 mm spacing. Each of the through holes had the porous resin layer of about 30 μm thickness. Gold plating was applied on the resin layer, and the gold plating coated the surface of a skeleton portion of the resin layer.

The thus-obtained product was employed as an anisotropic conductive sheet.

### Comparative Example

### Anisotropic Conductive Sheet Without Porous Resin Layer

There was prepared the same foamed sheet employed in the Example, and through holes were formed through perforation of the foamed sheet. However, a metal layer was formed directly on the foamed sheet by electroless plating.

The process was performed as follows. The same operations as those applied to the Example for electroless copper plating, electroless nickel plating, and displacement gold plating were performed, thereby forming a metal layer with a multi layer structure. Thereafter, both upper and lower surfaces of the foamed sheet were sliced, thereby obtaining a foamed sheet of 1 mm thickness, which was uniformly foamed. The foamed sheet had through holes formed with 1 mm spacing in its surfaces. An inner wall of each of the through holes was plated with metal of a multi layer structure, in which the inner surface was gold and the outer periphery was surrounded by copper. The thus-obtained product was employed as an anisotropic conductive sheet.

### Evaluation of Anisotropic Conductive Sheet

### Conductivity of the anisotropic conductive sheet obtained in the Example and that obtained in the Comparative Example were examined.

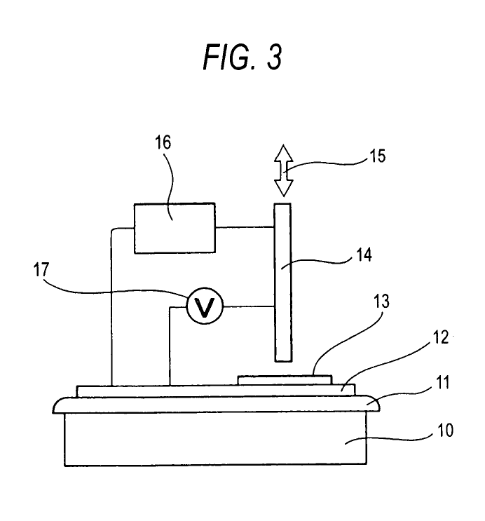

An apparatus used in the examination will be described by reference to the illustration in FIG. 3. A conductive plate 12 is placed on a gravimeter 10 with an electrically insulating layer 11 therebetween. The conductive plate 12 is formed from gold or plated with gold. An anisotropic conductive sheet 13 to be measured is placed on the conductive plate 12, and a probe 14 which can move in the direction indicated by the moving directions 15 is set above the sheet 13. The probe 14 is preferably formed from copper, or copper plated with gold. In the present example, a copper rod of 0.5 mm diameter was used. The probe 14 and the conductive plate 12 are electrically connected, and supplied with current therebetween with use of a constant current power source 16. Separately from the above, there is prepared a circuit in which the probe 14 and the conductive plate 12 are electrically connected with a voltmeter 17 therebetween.

The probe 14 was lowered so as to cover only a single through hole among the through holes on the anisotropic conductive sheet 13 placed on the apparatus. The probe applied a pressure to the sheet and plates. The amount of applied pressure was measured by the gravimeter 10, and a magnitude of contact resistance in relation to the amount of applied pressure was measured. The load required for bringing the contact resistance into a range of 100 μΩ or lower, which was an expected value, was 1.0 MPa for the sheet of the Example, and 4.2 MPa for the sheet of the Comparative Example. Since the load to be applied on the anisotropic sheet is generally about 5 MPa, both these two samples satisfied the value of the specifications.

On these sheets, 5 MPa, which is the above-mentioned general working load, was applied 100,000 times repeatedly at 30 seconds intervals, and thereafter the contact resistance values thereof were again measured with the apparatus illustrated in FIG. 3. The load required for bringing the contact resistance into the range of 100 μΩ or lower, which was the expected value, was 1.9 MPa for the sheet of the Example, and 5.0 MPa for the sheet of the Comparative Example. The load for each of the sheets shifted to a value equal to or lower than the expected value even after repetitive loading of 100,000 cycles.

However, from a viewpoint of the change in the contact resistance before the application of the load and the contact resistance after the application of the load, the load increased for each of the sheets. In particular, for the sheet of the Comparative Example, a great load is required, and the load after the repetitive loading increased to a value close to the limit (i.e., 5 MPa) of the general working load.

The present invention has been described in detail and with reference to the specific exemplary embodiment. However, as is apparent to one skilled in the art, various changes and modifications can be adopted without departing from the spirit and scope of the invention.

The present invention is based on Japanese Patent Application filed on Apr. 2, 2004 (JP-A-2004-109637), and the contents of which are hereby incorporated for reference.

### INDUSTRIAL APPLICABILITY

The anisotropic conductive sheet provided by the invention, which can attain conduction stably even under a light load, and endure repetitive use over a long term, is optimum for inspection of a semiconductor wafer, or the like.

What is claimed is:

1. An anisotropic conductive sheet, comprising:
an electrically insulating porous sheet;
a plurality of through holes perforated in a direction of the thickness of said electrically insulating porous sheet, each of said plurality of through holes comprising an inner wall;
a plurality of porous resin layers, each of said porous resin layers comprising an open-cell structure, said porous resin layers respectively formed on said inner walls of said plurality of through holes, said porous resin layers comprising skeleton portions; and
metal that coats said skeleton portions of said porous resin layers.

2. The anisotropic conductive sheet according to claim 1, wherein said electrically insulating porous sheet comprises a foamed fluororubber.

3. The anisotropic conductive sheet according to claim 1, wherein each of said porous resin layers is formed by a phase separation method.

4. The anisotropic conductive sheet according to claim 1, wherein each of said porous resin layers comprises a fluororubber.

5. The anisotropic conductive sheet according to claim 1, wherein each of said porous resin layers comprises a tetrafluoroethylene-propylene copolymer rubber subjected to radiation irradiation.

6. The anisotropic conductive sheet according to claim 1, wherein said metal comprises a first layer, comprising at least one member selected from the group consisting of gold, silver, and copper.

7. The anisotropic conductive sheet according to claim 6, wherein said metal further comprises an auxiliary layer comprising one or more of nickel, a nickel alloy, a precious metal, and a precious metal alloy.
